(19) United States
(12) Patent Application Publication
(10) Pub. No.: US 2008/0034632 A1
(43) Pub. Date: Feb. 14, 2008

(54) PRODUCT SHIPPING AND DISPLAY TRAY WITH INTEGRATED POP UP DISPLAY SIGN

(75) Inventors: Mark F. Urban, Villa Hills, KY (US); Carl M. Clark, Carrollton, KY (US); Mark A. Wassom, Independence, KY (US); John R. Duecker, Fairfield, OH (US)

Correspondence Address: CLAUSEN MILLER, P.C, SUITE 1600, 10S. LASALLE STREET, CHICAGO, IL, 60603, US

(73) Assignee: SONOCO DEVELOPMENT, INC., Hartsville, SC (US)

(21) Appl. No.: 11/463,068

(22) Filed: Aug. 8, 2006

(51) Int. Cl. G09F 15/00

(52) U.S. Cl. 40/610

(57) ABSTRACT

A product tray with an integral pop-up sign that can be displayed if desired, such as when extra lateral shelf space must be filled. The pop-up sign is disposed underneath the false bottom of the tray to save space during shipping or if it is not needed at the retail site. When removed from the tray the pop-up sign automatically raises. Multiple trays can be arranged side by side on a shelf with a pop-up sign displayed between them.

### BACKGROUND

1. Field of the Invention

This patent relates to a retail product shipping and display tray. More particularly, this patent relates to a retail product shipping and display tray having an integrated pop-up display sign.

2. Description of the Related Art

Many consumer products are displayed at retail stores in the same trays or containers in which they are shipped. The trays typically have a top cut away portion that can be removed by the retailer to allow easy access to the products by the purchaser. The trays can be placed directly on the retail store shelf to display the products inside, thus eliminating the need to manually remove each individual product and place it on the shelf.

Shipping trays that double as display trays can be time and labor saving for the retailer. However, retailers sometimes need or want to fill shelves of varying widths with the same display tray, but the display trays usually come in a single width. Retailers also sometimes want a display sign that is an integral part of the product tray to use as a “point of purchase” advertisement that can be easily assembled at the retail site. While product trays having integral display signs are known, most require hand assembly and are not designed to take up additional, excess lateral shelf space. The present invention is designed to fulfill these needs.

Thus it is an object of the invention to provide a product shipping tray that can be used to display the products at the retail store.

Another object of the invention is to provide an integral product tray and pop-up sign assembly.

Still another object of the present invention is to provide a product tray and pop-up sign assembly that can be altered to fill shelf space by withdrawing the pop-up sign from a space within the tray.

Yet another object of the present invention is to provide a pop-up sign that automatically erects when withdrawn from the space within the tray.

Further and additional objects will appear from the description, accompanying drawings, and appended claims.

### SUMMARY OF THE INVENTION

The present invention is a product display container with a stored display sign. The product display container and the display sign preferably are made from folded rigid materials such as paper or, more specifically, paperboard. The display sign is configured such that, when it is removed from a storage space within the product display container, it automatically expands to a raised position that is maintained by bias means (such as an elastic band). The bias means keeps a portion of the display sign—the graphics panel—in a position at least about 60 percent to vertical. That is, the graphics panel forms at least a 54 degree angle with the horizontal surface on which the display panel rests. This raised position enables consumers to view data (i.e., wording, graphics or other information) depicted on the graphics panel.

The display sign, or pop-up sign, is hidden underneath the false bottom of the product display container, or tray, and can be withdrawn from the tray and displayed or can remain within the false bottom of the tray

The pop up sign comprises a base panel, a display panel hingedly connected to the base panel along a fold line and two leg panels. Each leg panel is connected to the base panel along a fold line and to the display panel by attachment means such as adhesive. Each leg panel can be folded along a diagonal fold line and has a slot that bisects the diagonal fold line. An elastic band such as a common rubber band is secured within the two slots.

The pop up sign is convertible between a closed, folded position in which the display panel and the base panel form a first, relatively small angle, and an open, raised position in which the display panel and the base panel form a second, relatively larger angle. The elastic band biases the pop up sign in the open, raised position.

The tray comprises a bottom panel and a false bottom panel, a rear panel hingedly attached to the bottom panel along a fold line, and side panels hingedly attached to the rear panel along opposite fold lines. The bottom panel and the false bottom panel are arranged in a substantially parallel spaced relationship to each other to define a shallow space therebetween.

The pop-up sign is stored within this shallow space until use. When the pop-up sign is withdrawn at least partway from the shallow space between the bottom panel and the false bottom panel the pop-up sign automatically converts to the open, raised position.

### THE DRAWINGS

FIG. 1 is a perspective view of the product tray and pop-up sign assembly of the present invention.

FIG. 2 is a perspective view of the product tray and pop-up sign assembly of FIG. 1 shown as the pop-up sign pull tab is being grasped by a user.

FIG. 3 is a perspective view of the product tray and pop-up sign assembly of FIG. 1 shown as the pop-up sign is being withdrawn from its stored location.

FIG. 4 is a perspective view of the product tray and pop-up sign assembly of FIG. 1 shown with the pop-up sign completely withdrawn and the display panel erect.

FIG. 5 is a perspective view of the product tray and pop-up sign assembly of FIG. 4 shown next to a second product tray and pop-up sign assembly.

FIGS. 6-13 are perspective views of the pop-up sign of FIG. 1 shown in various stages of assembly.

FIG. 6 is a perspective view of the pop-up sign blank.

FIG. 7 is a perspective view of the pop-up sign blank of FIG. 6 with the two leg panels folded inward.

FIG. 8 is a perspective view of the pop-up sign blank of FIG. 7 with the leg panel glue tabs folded outward.

FIG. 9 is a perspective view of the pop-up sign blank of FIG. 8 with the display panel folded back against the base panel so that the glue tabs can adhere to the back of the display panel.

FIG. 10 is a perspective view of the pop-up sign blank of FIG. 9 after the display panel has been raised and before the elastic band is attached to the leg panels.

FIG. 11 is a perspective view of the pop-up sign blank of FIG. 10 after the elastic band has been attached to the leg panels to form the assembled pop-up sign.

FIG. 12 is a perspective view of the pop-up sign of FIG. 11 with the leg panels being splayed outward.

FIG. 13 is a perspective view of the pop-up sign of FIG. 12 with the display panel folded back against the base panel prior to inserting the pop-up sign within the product tray.

FIGS. 14-20 are perspective views of the product tray of FIG. 1 shown in various stages of assembly.

FIG. 14 is a perspective view of the product tray blank.

FIG. 15 is a perspective view of the product tray blank of FIG. 14 with the two side panels folded upward and the two bottom panels folded inward.

FIG. 16 is a perspective view of the product tray blank of FIG. 15 in a further state of assembly.

FIG. 17 is a perspective view of the product tray blank of FIG. 16 in a further state of assembly.

FIG. 18 is a perspective view of the product tray blank of FIG. 17 in a further state of assembly.

FIG. 19 is a perspective view of the product tray blank of FIG. 18 in a further state of assembly.

FIG. 20 is a perspective view of the assembled product tray of FIG. 1 prior to the pop-up sign being placed within the tray.

### DETAILED DESCRIPTION OF THE INVENTION

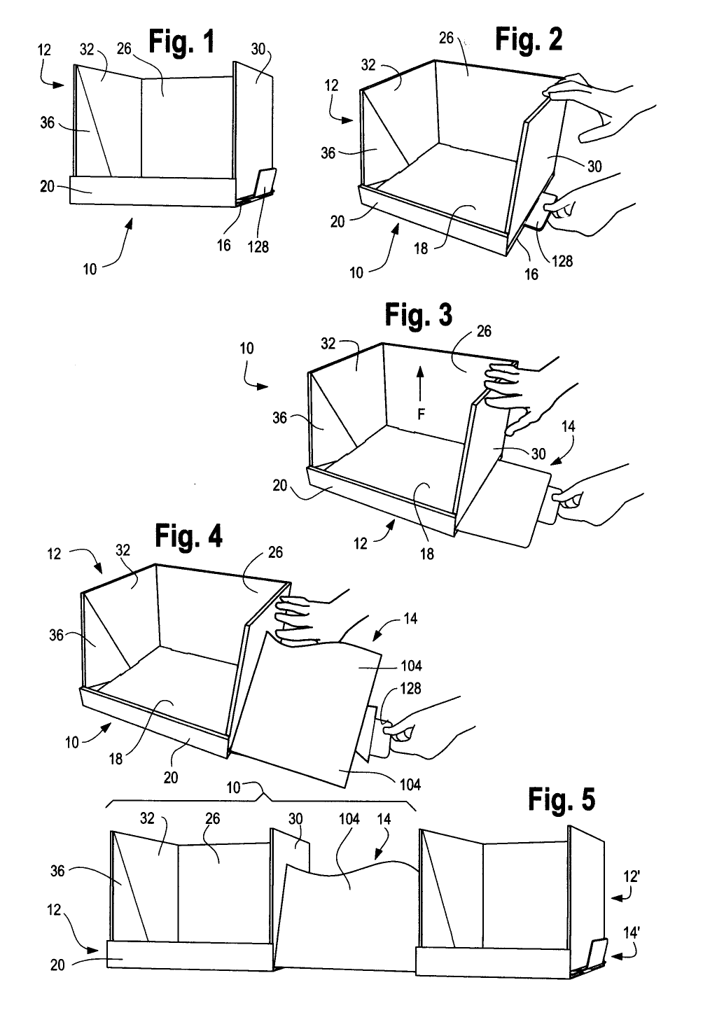

Turning to the drawings, there is shown in FIG. 1 one embodiment of the present invention, an assembly 10 comprising a tray 12 for shipping and displaying products and an integrated pop-up display sign 14. The pop-up sign 14 hides under the false bottom of the tray 12. The sign 14 can be removed and displayed if desired, such as when extra lateral shelf space must be filled, or it can remain under the false bottom of the tray to save space during shipping or if it is not needed at the retail site. Multiple assemblies 10 can be arranged side by side on a shelf with a pop-up sign 14 displayed between them if desired.

Tray Construction and Assembly

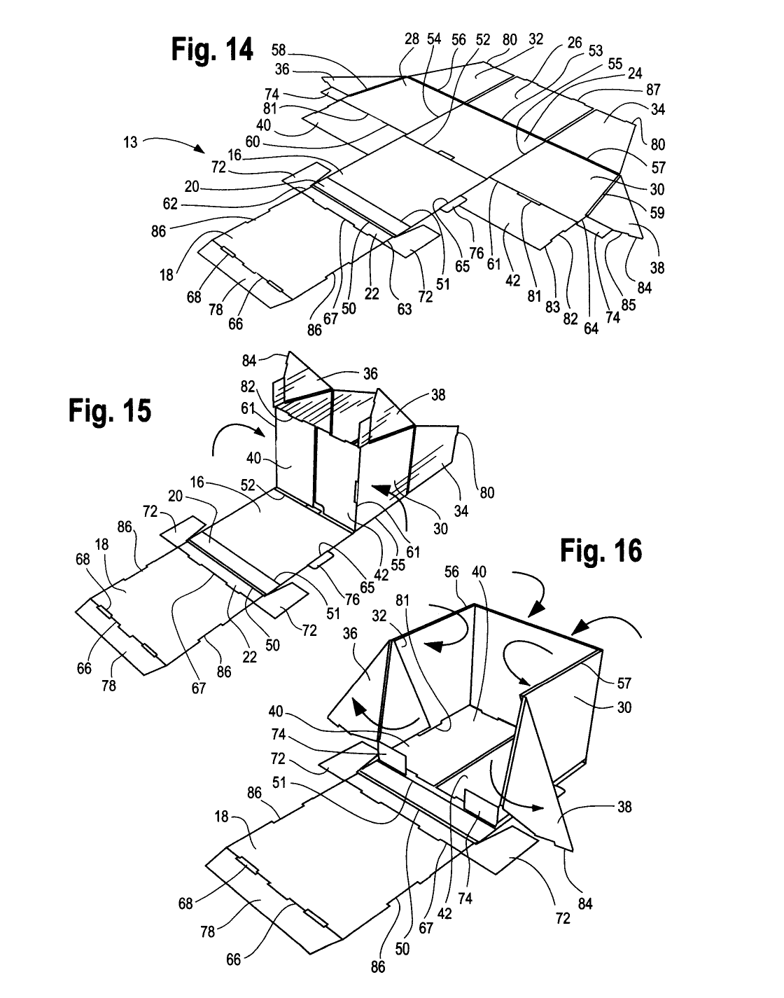

Referring to FIG. 14, the tray 12 is formed from a single blank 13 comprising the following major components: a bottom panel 16, a false bottom panel 18, outer and inner facing short front panels 20, 22, outer and inner facing rear panels 24, 26, opposing left and right side panels 28, 30, left and right trapezoidal inner side panels 32, 34, left and right angled side panels 36, 38, and left and right bottom flaps 40, 42.

The outer and inner short front panels 20, 22 are connected to each other along a double (180 degree) fold line 50. The bottom panel 16 is connected to the outer front panel 20 along a single (90 degree) fold line 51. The outer rear panel 24 is connected to the bottom panel 16 along a single fold line 52. The inner rear panel 26 is connected to the outer rear panel 24 along a fold line 53. The left and right side panels 28, 30 are connected to the bottom panel 16 along a single fold lines 54, 55. The trapezoidal left and right inner side panels 32, 34 are connected to the left and right side panels 28, 30 respectively along fold lines 56, 57. Their remaining three sides are free edges. The left and right angled side panels 36, 38 are connected to the left and right side panels 28, 30 along double fold lines 58, 59. The bottom flaps 40, 42 are connected to the lower edges of the left and right side panels 28, 30 respectively along fold lines 60, 61. The false bottom is connected to the inner front panel 22 by a fold line 67.

In addition to the major components described above, the tray blank 13 comprises the following minor components: pentagonal inner side tabs 72, rectangular tabs 74, a lock tab 76 and an elongated flap 78. The pentagonal tabs 72 are connected to opposing edges of the inner front panel 22 along fold lines 62, 63. The remaining edges of pentagonal tabs 72 are free edges. Rectangular tabs 74 are connected to the left and right side panels 28, 30 along fold lines 64 opposite fold lines 54, 55. The lock tab 76 is connected to the right edge of the bottom panel 16 along a fold line 65. Elongated flap 78 is connected to the false bottom along fold line 66.

The trapezoidal panels 32, 34 have tabs 80 located along their free edge opposite folds 56, 57. These tabs 80 fit within slots 81 located along the fold lines 60, 61 that connect the bottom flaps 40, 42 to the side panels 28, 30. The left and right bottom flaps 40, 42 each have a notch 82 cut out of their forward edge 83. The left and right angled side tabs 36, 38 have smaller tabs 84 extending from their bottom edges 85. These tabs 84 also fit within slots 81. Notches 86 located along opposite side edges of false bottom panel 18 prevent the false bottom panel 18 from covering slots 81 in the assembled tray 12. The inner rear panel 26 has tabs 87 that fit within slots 68 located along the fold line 66 connecting the false bottom panel 18 and the elongated tab 78.

As shown in FIGS. 14-20, the tray 12 may be assembled in a fold and lock manner without the need for adhesive according to the following steps:

(a) Beginning with the flat blank 13 (FIG. 14), fold up (rotate 90 degrees) the left and right side panels 28, 30 along fold lines 54, 55 as shown in FIG. 15.

(b) Still referring to FIG. 15, fold in the bottom flaps 40, 42 along the fold lines 60, 61.

(c) Referring to FIG. 16, fold over the left and right trapezoidal inner side panels 32, 34 along double fold lines 56, 57 until they are adjacent to (in facing parallel relationship with) the outer side panels 28, 30. Lock the trapezoidal inner side panels in place by inserting side panel tabs 80 into slots 81. Fold the outer rear panel 24 along fold line 52 until the bottom flaps 40, 42 are adjacent to (flat against) the bottom panel 16. Fold out the left and right angled side tabs 36, 38. Fold rectangular tabs 74 inward.

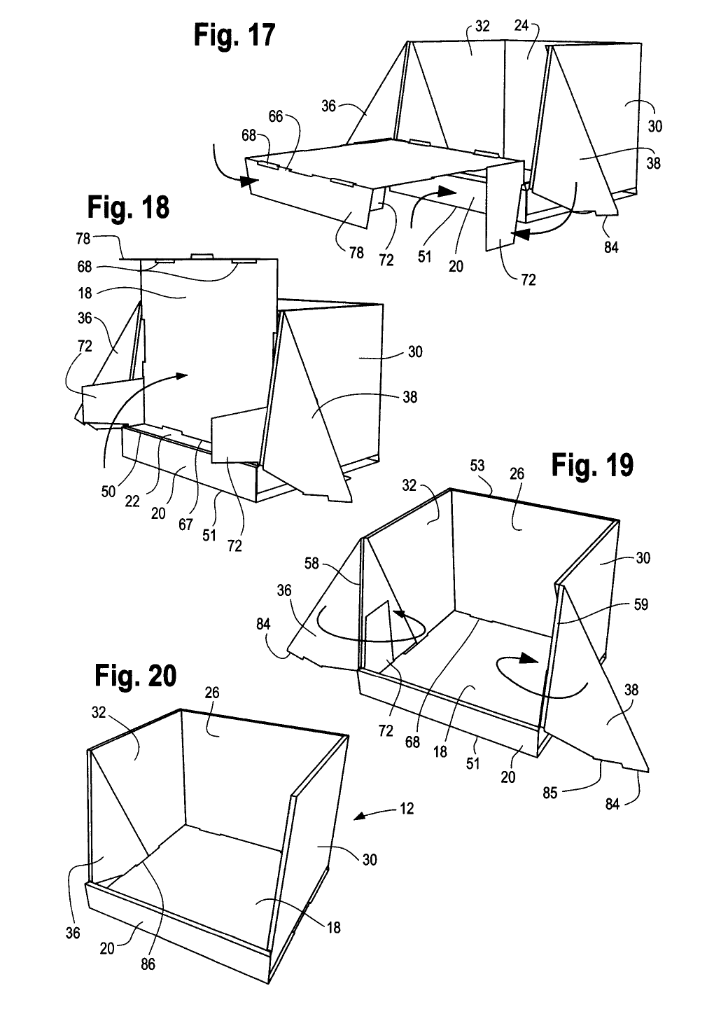

(d) Referring to FIGS. 17-19, bring the false bottom panel 18 in by folding along fold lines 50, 51 and 67 until the false bottom panel 18 is in place above the bottom panel 16. The rectangular tabs 74 should be secured between the outer and inner front panels 20, 22. The pentagonal tabs 72 should be adjacent the side panels 28, 30 as shown in FIG. 19.

(e) Referring to FIG. 19, bring over the inner rear panel 26 by folding along double fold line 53 and insert tabs 87 into slots 68. This will secure the false bottom panel 18 in place.

(f) Still referring to FIG. 19, fold the angled side panels 36, 38 around angled fold lines 58, 59 and insert tabs 84 into slots 81. The angled side panels 36, 38 should cover and secure in place the pentagonal inner front panel tabs 72.

(g) Referring to FIG. 20, fold lock tab 76 in on itself so that it is disposed within the space between the false bottom panel 18 and the bottom panel 16. The function of the lock tab 76 is explained below.

In the constructed tray 12 shown in FIG. 20, the bottom and false bottom panels 16, 18 are arranged in substantially parallel spaced relationship to each other to define a space therebetween for receiving the pop-up sign 14. The false bottom panel 18 serves as the surface on which the products are placed for shipping and display, while the bottom panel 16 serves as the actual tray bottom. Various tray inserts (not shown) may be used to further secure the products on the tray 12.

Pop-Up Sign Construction and Assembly

The construction and assembly of the pop-up sign 14 shown in FIGS. 6-13 will now be described. As shown in FIG. 6, the pop-up sign 14 is formed from a blank 100 that is folded and glued. The blank 100 comprises a base panel 102, a graphic or display panel 104, and two leg panels 106, 108. The display panel 104 is attached to the base panel 102 along a fold line 110. The leg panels 106, 108 are connected to the base panel 102 along fold lines 112, 114. Each leg panel 106, 108 has a diagonal fold line 116 disposed therein and an arcuate, die cut slot 118 that bisects the fold line 116 and defines a tongue 120. A glue tab 122 is attached to each leg panel along a fold line 124 and is affixed to the rear side of the display panel 102. The front side of the display panel 104 may contain point-of-purchase advertising or any other desirable graphic.

As illustrated in FIGS. 6-13, the pop-up sign 14 is assembled in the following manner:

(a) Referring to FIG. 6, place the blank 100 on a flat surface with the graphics side of the display panel 104 down.

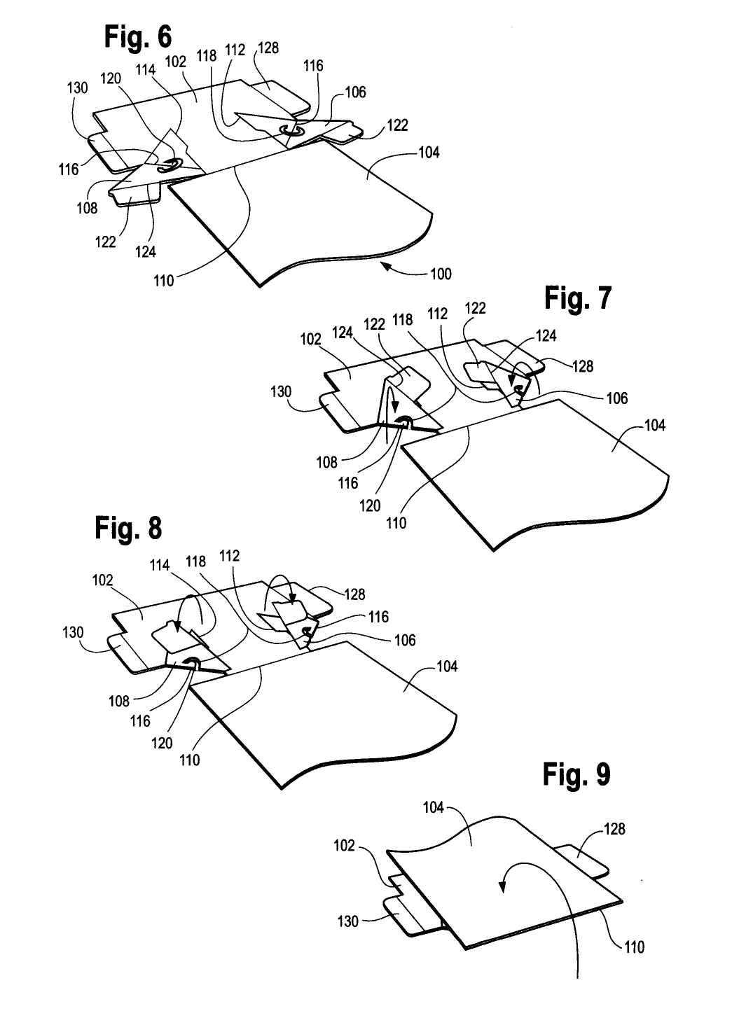

(b) As shown in FIG. 7, fold the two leg panels 104, 106 inward (toward each other) along their diagonal fold lines 116.

(c) As shown in FIG. 8, fold back the glue tabs 122 at the fold lines 124 and place adhesive, such as a hot melt adhesive, on the kraft side of the tabs 122.

(d) Fold the display panel 104 back along the fold line 110 until its rear side lies flat against the glue tabs 122, as shown in FIG. 9.

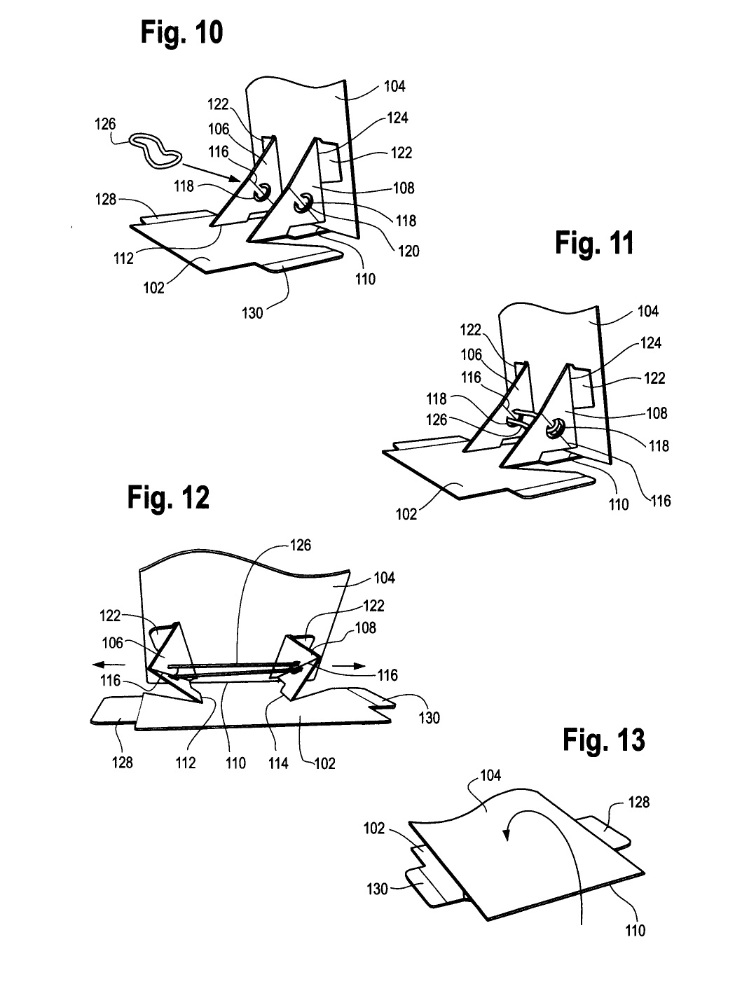

(e) Open the glued assembly once it has dried (FIG. 10). Take an appropriately sized elastic band 126 such as an ordinary rubber band and thread it through the die cut slots 118 in each leg panel 106, 108 by feeding it through one slot 118 at a time until the elastic band 126 is suspended between the legs 106, 108 as shown in FIG. 11.

(f) Fold out the leg panels 106, 108 as shown in FIG. 12 so that the elastic band 126 is stretched and the pop-up sign 14 is as flat as possible. When the display panel 104 is folded flat against the base panel 102 as shown in FIG. 13, the display panel 104 and the base panel 102 form a relatively small angle with respect to one another, and the leg panels 106, 108 are splayed outward (bent away from each other along their diagonal fold lines 116). The elastic band 126 is stretched between the two arcuate slots 118 by the tongues 120 located in each leg panel 106, 108. As a consequence, the stretched elastic band 126 will bias the pop-up sign 14 in an open, or raised position.

(g) While holding down the display panel 104, fold the locking tab 130 on the left side completely back upon itself.

Tray and Pop-Up Sign Assembly

As shown in FIGS. 1-4, the pop-up sign 14 can be pushed or slid into or out of the shallow space between the bottom panels 16, 18 of the product tray 12 to create the tray and pop-up sign assembly 10. The pop-up sign 14 includes a right side pull tab 128 that emerges from the tray bottom space. When the pull tab 128 is used to withdraw the sign 14 a sufficient distance from the space underneath the false bottom 18 of the tray 12 the sign 14 self-erects (automatically pops up), as shown in FIG. 4.

The pop-up sign locking tab 130 (FIGS. 6-13) prevents the pop-up sign 14 from being completely withdrawn from the tray 12 by engaging the tray locking tab 76 (FIG. 14). The pop-up sign locking tab 130 also helps align the pop-up sign 14 with the tray 12.

FIGS. 1-4 show a right-handed tray 12 and pop-up sign 14 configuration, i.e., a configuration in which the pop-up sign 14 is displayed to the right of the tray 12. It should be understood that the tray and pop-up sign can also be designed for a left-handed configuration.

The tray 12 can be made to any desired dimensions depending on the product size and quantity, and can be used (placed on display) with or without the pop-up sign 14. For example, if a retailer wishes to fill out more shelf space that that occupied by the tray 12 alone, they can pull on the pull tab 128 to reveal the pop-up sign 14.

A second tray 12 may be incorporated into the shelf display as shown in FIG. 5. In this arrangement, the assembled second tray 12′ (with pop-up sign 14′ kept within the tray 14′) is placed alongside the first tray and pop-up sign assembly 10.

The tray and pop-up sign assembly 10 may be used to ship and display any suitable packaged product, including but not limited to personal care products, food items and household goods. In addition to the forward facing side of the display panel 104, point-of-sale advertising or other graphics may be added to the tray 12 on, for example, the outer front panel 20 or the side panels 28, 30.

Preferably the pop-up sign is constructed from corrugated board, and more particularly, E-flute corrugated board. The shipping and display tray 12 may also be constructed from corrugated or any other suitable material. If corrugated is used it is preferable that the flutes are oriented in the vertical direction as indicated by arrow F in FIG. 3.

It should be understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

We claim as our invention:

1. A pop up sign comprising:
a base panel;
a display panel hingedly connected to the base panel along a first fold line;
two leg panels, each leg panel connected to the base panel along a second fold line and to the display panel by attachment means, each leg panel being foldable along a diagonal fold line and having a slot bisecting the diagonal fold line; and
an elastic band secured within the two slots;
wherein the pop up sign is convertible between a closed, folded position in which the display panel and the base panel form a first, relatively small angle, and an open, raised position in which the display panel and the base panel form a second, relatively larger angle; and
wherein the elastic band biases the pop up sign in the open, raised position.

2. The pop up sign of claim 1 further comprising a glue tab attached to each leg panel along a fold line, the glue tabs being secured to a rear side of the display panel by adhesive.

3. The pop up sign of claim 2 wherein a front side of the display panel opposite the rear side bears graphics.

4. The pop up sign of claim 1 wherein, in the closed, folded position the leg panels are splayed outward away from each other.

5. The pop up sign of claim 4 wherein the slots are arcuate.

6. A tray and pop-up sign assembly comprising:
a tray comprising a bottom panel and a false bottom panel, a rear panel hingedly attached to the bottom panel along a fold line, and side panels hingedly attached to the rear panel along opposite fold lines, the bottom panel and the false bottom panel arranged in substantially parallel spaced relationship to each other to define a shallow space therebetween; and
the pop-up sign of claim 1 disposed within the shallow space in its closed, folded position;
wherein when the pop-up sign is withdrawn from the shallow space between the bottom panel and the false bottom panel the pop-up sign automatically converts to the open, raised position.

7. The tray and pop-up sign assembly of claim 6 wherein the pop-up sign further comprises a pull tab that may be used to withdraw the pop-up sign from the shallow space between the bottom panel and the false bottom panel.

8. The tray and pop-up sign assembly of claim 7 wherein the tray and pop-up sign comprise locking tabs that engage each other to prevent the pop-up sign from being completely withdrawn from the tray.

9. The tray and pop-up sign assembly of claim 6 wherein the tray further comprises an outer front panel hingedly attached to the bottom panel.

10. The tray and pop-up sign assembly of claim 6 wherein the tray is formed from a folded blank.

11. A product display container with stored display sign, the product display container and the display sign being made from folded rigid materials, the display sign being configured such that, when the display sign is removed from a storage space within the product display container, the display sign automatically expands to a second position that is maintained by bias means that keeps a portion of the display sign in a position at least about sixty percent to vertical to enable consumers to view information contained on said portion of the display sign.

12. The product display container with stored display sign of claim 11 wherein the product display container comprises a pair of parallel, spaced, horizontally disposed panels that define the storage space within which the display sign is stored.

13. The product display container with stored display sign of claim 11 wherein said portion of the display sign is a graphic panel, and wherein the display sign further comprises a base panel in angular relationship with the graphic panel.

14. The product display container with stored display sign of claim 13 wherein the display sign further comprises two foldable legs connected to both the base panel and the graphic panel.

15. The product display container with stored display sign of claim 14 wherein the bias means comprises an elastic band connecting the two legs.

16. The product display container with stored display sign of claim 11 further comprising means for preventing the display sign from being completely removed from the storage space within the product display container.

17. The product display container with stored display sign of claim 16 wherein the preventing means comprises tabs that engage each other as the display sign is being removed, one tab being an integral part of the product display container and the other tab being an integral part of the display sign.
